(19) United States
(12) Patent Application Publication
(10) Pub. No.: US 2010/0323169 A1
(43) Pub. Date: Dec. 23, 2010

(54) CUSTOM MOSAIC FLOORING AND METHOD FOR CONSTRUCTING THE SAME

(76) Inventors: Jong-Seok Son, Chungcheongbuk-do (KR); Hyun-Jong Kwon, Chungcheongbuk-do (KR)

Correspondence Address: MCKENNA LONG & ALDRIDGE LLP, 1900 K STREET, NW, WASHINGTON, DC, 20006, US

(21) Appl. No.: 12/745,215

(22) PCT Filed: Dec. 13, 2007
(86) PCT No.: PCT/KR07/06496

§ 371 Date: May 27, 2010

(51) Int. Cl. E04B 5/00; B32B 3/10

(52) U.S. Cl. 428/189; 52/746.12

(57) ABSTRACT

A custom mosaic flooring enabling customized construction of a flooring is disclosed. More specifically, according to the present invention, a sheet-type flooring printed with specific desired patterns or actual photograph printing images is constructed at a desired position in a partial mosaic form. According to the present invention, the custom mosaic flooring is constructed by printing various patterns including mosaic patterns, carpet patterns, pictures, and graphic patterns using a variety of printing methods including gravure printing, offset printing, transfer printing, dye diffusion thermal transfer printing, silkscreen printing, and actual photograph printing using a printer, thereby fabricating a sheet-type flooring, and fitting thus-fabricated flooring into a desired position. Therefore, construction of the flooring can be conveniently achieved.

### TECHNICAL FIELD

The present invention relates to a custom mosaic flooring and a method for constructing the same, and more particularly to a custom mosaic flooring and a method for constructing the same, capable of enabling continuous printing by various printing methods including actual photograph printing, gravure printing, transfer printing and silkscreen printing, enabling printing of various patterns and shapes as desired, and minimizing the number of exposed seams when constructing the above-produced flooring patterns by saving the necessity of seaming lots of patterns as conventional, finally such that a variety of interiors can be designed conveniently.

### BACKGROUND ART

Conventionally, a mosaic flooring is constructed by preparing flooring sheets by color, cutting the flooring sheets into desired patterns and shapes, and then placing the cut pieces at proper positions.

According to the conventional method, when constructing a specific type of mosaic flooring, flooring sheets of various colors and patterns are partially cut and the cut pieces are fitted to one another at proper positions.

The above construction method for mosaic flooring is inefficient since it requires long construction time and expert skill. Furthermore, maintenance after the construction is difficult because exposed seams are easily contaminated.

Although JP Patent Laid-open Publication No. 2000-27414 discloses “method of repairing a Japanese floor mat,” the method is slightly relevant to the present invention which is related to a construction method for a sheet-type flooring.

JP Patent Laid-open Publication No. 2004-183453 discloses “an adhesive sheet with floor mat” in which the adhesive sheet having a printed side is attached to floor mat. However, this is also different from the present invention.

JP Patent Laid-open Publication No. 2005-179970 discloses “underlaying tile floor material” related to a tile-type flooring comprising protection films separably fixed to a tile main body. However, this is also only slightly relevant to the present invention, either.

Also, “a designed tile and a construction method for the same” is disclosed in JP Patent Laid-open Publication No. 1997-125665. Since this invention is related to a combination of assorted designed tiles, it also bears the same problems as the present invention.

### DISCLOSURE

### Technical Problem

Therefore, the present invention has been made in view of the above problems, and it is an object of the present invention to provide a custom mosaic flooring and a method for constructing the same, capable of minimizing the number of cutting and seam-bonding processes, reducing the construction time with the construction method improved in convenience, and also reducing potential inferiority caused by the reduction of seams.

It is another object of the present invention to provide a custom mosaic flooring capable of being constructed with desired patterns, sizes and positions as consumers want when designing the interior, and a method for constructing the same.

### Technical Solution

In accordance with an aspect of the present invention, the above and other objects can be accomplished by the provision of a custom mosaic flooring comprising a first flooring including printed patterns thereon and a second flooring into which the first flooring is inserted on the same plane, wherein seams between the first flooring and the second flooring are connected by an adhesive.

According to an embodiment of the present invention, the first flooring is partially inserted into the second flooring. The first flooring may have a regular shape such as a circle, an oval and other polygons including a triangle and a square, or an irregular shape. Also, two or more first floorings can be used in variable arrangements.

According to another embodiment of the present invention, the first flooring may be inserted between two second floorings.

Considering compatibility between different floorings, both of the first flooring and the second flooring are preferably made of the same material and by the same thickness.

In the embodiment of the present invention, printed patterns include at least one among mosaic patterns, carpet patterns, pictures, and graphic patterns. The printed patterns are continuously printed in a desired size.

The adhesive to bond the seams between the first and second floorings is implemented by solvent adhesive or hot-melt adhesive.

In accordance with another aspect of the present invention, there is provided a method for constructing a custom mosaic flooring comprising fabricating a first flooring printed with desired patterns, cutting out the first flooring to a desired size, cutting out a second flooring to a corresponding size of a cutout piece of the first flooring, and inserting and bonding the cutout piece of the first flooring into the second flooring.

The printing may be performed by at least one among gravure printing, offset printing, transfer printing, dye diffusion thermal transfer printing, silkscreen printing, and actual photograph printing using a printer. Especially, the actual photograph printing is preferred for the printing method. The actual photograph printing may be performed by at least one among inkjet printing, UV printing, and transfer printing.

The present invention relates to a method for constructing sheet-type partial mosaic flooring. According to this, first, a flooring is fabricated by printing photos, pictures or patterns by a specific unit on a foamed or non-foamed sheet using various printing methods such as large actual photograph printing that uses water-based or oil-based inkjet printing, UV printing, transfer printing and so forth, gravure printing, offset printing, transfer, dye diffusion thermal transfer printing, and silkscreen printing. Then, thus-fabricated flooring having a specific shape and an actual photograph printing picture thereon is constructed in combination with an existing flooring sheet, by being fitted into an existing flooring sheet in a substitutional manner.

According to the present invention, the number of cutting and seam-bonding processes can be minimized while saving the construction time by the improved construction method. Potential inferiority that may be generated due to the reduced number of seams can also be reduced. Moreover, when designing the interior, the flooring can be constructed as desired by consumers regarding patterns, size and position.

### DESCRIPTION OF DRAWINGS

The above and other objects, features and other advantages of the present invention will be more clearly understood from the following detailed description taken in conjunction with the accompanying drawings, in which:

FIG. 1 is a perspective view of a custom flooring according to an embodiment of the present invention; and

FIG. 2 is a perspective view of a custom flooring according to another embodiment of the present invention.

### BEST MODE

Hereinafter, an exemplary embodiment of the present invention will be described in detail with reference to the accompanying drawings.

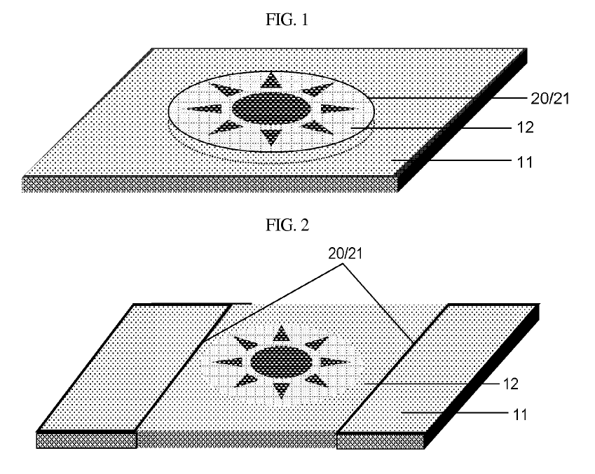

FIGS. 1 and 2 are perspective views showing the construction structure for a sheet-type flooring in which the number of seams are minimized.

According to the construction structure shown in FIG. 1, a constructed flooring is partially cut out by specific shapes. Next, another flooring printed with desired patterns or images thereon is cut into the same shapes as the cutouts of the existing flooring. The cutout pieces having the printed patterns or images are fitted in the removed portions of the existing flooring in a substitutional manner. Therefore, this method is mainly used for remodeling.

More particularly, referring to FIG. 1, a first flooring 12 which is a custom flooring having a circular shape is partially fitted in a second flooring 11 which is an existing flooring, that is, a prefabricated base flooring having a sheet form. Seams between the first flooring 12 and the second flooring 11 may be processed in the form of a solvent adhesive seam 20 or a hot-melt adhesive seam 21.

FIG. 2 illustrates the construction method in which the custom flooring is seamed with a general base flooring from the first. This method is usually applied when newly constructing the whole flooring.

More specifically, the first flooring 12 which is the custom printed flooring is fitted between the second floorings 11 which is the existing base flooring in a sheet form. Also, seams between the first flooring 12 and the second flooring 11 may be processed in the form of the solvent adhesive seam 20 or the hot-melt adhesive seam 21.

Hereinafter, a method for constructing a custom mosaic flooring according to the embodiment of the present invention will be described in great detail.

First, the first flooring 12, a custom printed flooring sheet, is fabricated. The first flooring 12 may be made of a plastic material such as polyvinyl chloride or olefin in the form of a sheet.

For the printing methods, large photograph printing is applicable in this embodiment, which comprises UV printing which uses UV paints and cures the paints by UV rays, inkjet printing which jets water-based or oil-based paints by an inkjet printer and dries the jet paints, film transfer printing which prints water-based or oil-based paints on a thermal transfer film and transfers the printed paints from the transfer film to a printing object by heat or pressure, and the like. Besides, the printing methods further include gravure printing, transfer printing, offset printing, dye diffusion thermal transfer printing, silkscreen printing and the like. Using such various methods, a sheet-type material with photograph-printed images or custom patterns can be obtained.

Next, as shown in FIG. 1, the first flooring 12 is placed on a desired position of the second flooring 11 having the same thickness as the first flooring 12. The first flooring 12 and the second flooring 11 are cut by a desired size simultaneously. A cutout piece of the second flooring 11 is removed, and the first flooring 12 printed with a specific pattern is fitted into the removed portion of the second flooring 11.

When newly constructing the whole flooring, as shown in FIG. 2, the first flooring 12 is cut into a wide piece, and the wide piece is and seamed between two second floorings 11 partially cut by corresponding shape to the wide piece of the first flooring 12.

Then, seams between the mosaic-constructed first and second floorings 12 and 11 are bonded to each other in order to prevent the floorings 12 and 11 from being separated by external force such as stepping force.

When finishing the seams, chemical bonding applying a chemical reaction and chemical/physical bonding, for example, using hot-melt adhesive may be used.

More specifically, solvent adhesive containing organic or inorganic binder such as acryl is jet onto the seams using a special kit to bond and fix the seams to each other. Alternatively, a welding rod in the type of the hot-melt adhesive, which is made of the same material as the flooring or a material having excellent compatibility, may be heated and inserted in the gap between the seams to bond the seams to each other.

### MODE FOR INVENTION

The first flooring 12 and the second flooring 11 are fabricated to contain polyvinyl chloride resin, phthalate-based plasticizer, other additives and filling, in the form of a 1.8˜2.5 mm thick sheet. Here, the first and second floorings 12 and 11 have almost the same thickness so that height difference at seams between the first and second floorings 12 and 11 is not generated. The first flooring 12 is placed on a desired position of the second flooring 11 and the first and second floorings 12 and 11 are simultaneously cut by a desired size. As shown in FIG. 1, the cutout piece of the second flooring 11 is removed, and the first flooring 12 holding a specific printed pattern is fitted into the removed portion of the second flooring 11. Seams between the first and second floorings 12 and 11 are bonded to each other using a solvent adhesive 20 that slightly fuses the first and second floorings 12 and 11.

### INDUSTRIAL APPLICABILITY

Conventional floorings and construction methods for the same are restricted in changing the exterior appearance. Differently from the conventional arts, the present invention enables consumers to directly select patterns and shapes of the flooring and design the position of interior materials as desired. Therefore, the interior floor can be designed according to the consumers' individual taste.

In order to design the flooring so freely as above, a convenient construction method and reliable construction quality are required. According to the present invention, while minimizing the number of seams, the seams are bonded using general sheet-seaming methods including chemical bonding and hot-melt adhesive bonding. As a result, appearance and property of the seams can be improved while facilitating the construction method.

1. A custom mosaic flooring comprising:
a first flooring including printed patterns thereon; and
a second flooring into which the first flooring is inserted on the same plane,
wherein seams between the first flooring and the second flooring are connected by an adhesive.

2. The custom mosaic flooring according to claim 1, wherein the first flooring is partially inserted into the second flooring.

3. The custom mosaic flooring according to claim 1, wherein the first flooring is inserted between two second floorings.

4. The custom mosaic flooring according to claim 1, wherein both of the first flooring and the second flooring are made of the same material and by the same thickness.

5. The custom mosaic flooring according to claim 1, wherein the printed patterns include at least one of mosaic patterns, carpet patterns, pictures and graphic patterns.

6. The custom mosaic flooring according to claim 5, wherein the printed patterns are continuously printed in a desired size.

7. The custom mosaic flooring according to claim 1, wherein the adhesive is a solvent adhesive or a hot-melt adhesive.

8. A method for constructing a custom mosaic flooring comprising:
fabricating a first flooring printed with desired patterns;
cutting out the first flooring to a desired size;
cutting out a second flooring to a corresponding size of a cutout piece of the first flooring; and
inserting and bonding the cutout piece of the first flooring into the second flooring.

9. The method according to claim 8, wherein the first flooring is printed by at least one of gravure printing, offset printing, transfer printing, dye diffusion thermal transfer printing, silkscreen printing, and actual photograph printing using a printer.

10. The method according to claim 9, wherein the actual photograph printing is performed by at least one of inkjet printing, UV printing, and transfer printing.
